(19) United States
(12) Patent Application Publication
(10) Pub. No.: US 2025/0381610 A1
(43) Pub. Date: Dec. 18, 2025

(54) WELDING METHOD AND PRODUCT FOR IMPROVING STRESS CORROSION RESISTANCE OF RISER WELDED JOINT

(71) Applicant: Tianjin University, Tianjin (CN)

(72) Inventors: Lianyong Xu, Tianjin (CN); Yongdian Han, Tianjin (CN); Liang Li, Tianjin (CN); Yusheng Yan, Tianjin (CN); Kangda Hao, Tianjin (CN); Lei Zhao, Tianjin (CN)

(73) Assignee: Tianjin University, Tianjin (CN)

(21) Appl. No.: 19/071,757

(22) Filed: Mar. 6, 2025

(30) Foreign Application Priority Data
Jun. 13, 2024 (CN) 202410757806.9

(51) Int. Cl. B23K 9/173; B23K 101/04

(52) U.S. Cl. CPC B23K 9/173; B23K 2101/04

(57) ABSTRACT

This disclosure relates to a welding method for improving the stress corrosion resistance of a welded joints of a riser pipe and a product thereof. The welding method including: using CMT to weld SCR riser pipe under a shielding gas of 80% Ar+20% CO₂. The welding current for the root pass and fill pass is 180 A to 200 A, and the welding voltage is 20 V to 23 V, and the welding speed is 400 mm/min to 500 mm/min; the welding current of the cover pass is 130-150 A, the welding voltage is 13-15 V, and the welding speed is 245 mm/min to 255 mm/min.

### CROSS-REFERENCE TO RELATED APPLICATION

This application claims the priority benefit of China application serial no 202410757806.9, filed on Jun. 13, 2024. The entirety of the above-mentioned patent application is hereby incorporated by reference herein and made a part of this specification.

### TECHNICAL FIELD

The disclosure belongs to the field of marine pipe welding, and more particularly, relates to a welding method and product for improving stress corrosion resistance of riser welded joint.

### RELATED ART

With the increase of the global economic level and the acceleration of industrial processes, the demand of human beings for primary energy such as petroleum and natural gas is increasing, but the rapid reduction of land resources and serious damage to the ecological environment lead to blocking of primary energy development. The development and utilization of marine resources are promoted, and the development of marine economy has become the focus of national development in the future. Marine petroleum resource development and transportation need to be achieved by means of submarine pipelines and marine riser, steel catenary riser (SCR) is formed by welding some standard lengths of steel pipes, the submarine pipeline and the riser are integrated, and can run in extreme working environments such as high-temperature and high-pressure and harsh marine environments, which effectively reduces the cost of deep-sea riser, and haves a large volume of floating body drift and heave motion, so that the steel catenary riser becomes an important system of an offshore floating platform and a submarine pipeline.

The submarine pipeline should overcome the influence of severe environment such as wave, flow, corrosion and the like, and H₂S is widely existing in oil and gas resources, and when the H₂S in the medium conveyed by the oil and gas pipeline is relatively high, hydrogen in H₂S will be enriched at defects such as non-metallic inclusions and segregation bands, leading to the initiation of hydrogen induced cracking of the pipeline and sulfide stress corrosion cracking (SSCC or SSC). The pipeline in seabed often suffers from corrosion cracking, which brings high quality requirements to marine oil and gas pipelines. If the pipeline corrosion damage causes oil and gas leakage, it will not only stop the offshore oil field, and cause serious economic losses and marine pollution, but also will causes serious marine pollution. Such pollution is difficult to remove, and it effects can last for decades, causing incalculable damage to marine ecology.

X65 is the main steel grade used in the acidic environment of deep sea in China. For oil and gas transportation, welding is a common means to connect pipelines. However, the Coarse Grain Heat Affected Zone (CGHAZ) was formed in the base metal adjacent to the fusion line due to the high peak temperature during welding heating. The grain coarsening of this area is serious, and the brittleness of the transition product is also maximum, and the toughness is deteriorated, which is the most likely region to fail in the welded joint.

Cold Metal Transfer technology (CMT) adopts welding withdrawal technology to avoid the heating effect of short circuit current on the weld pool, and has the characteristics of low heat input and stable arc, which can improve the forming quality of welded joints and the welding efficiency. At present, CMT welding technology is gradually applied to the backing welding of pipelines, which reduces the stress concentration of joints and increases the corrosion fatigue life by optimizing the microstructure and reducing the stress concentration at the welding root. However, low heat input can easily lead to high hydrogen diffusion coefficient and high CGHAZ hardness of welded joints, which leads to the increase of stress corrosion sensitivity of welded joints. Therefore, how to achieve the improvement of anti-fatigue and anti-hydrogen sulfide stress corrosion performance is a problem to be solved.

### SUMMARY OF INVENTION

In view of the defects found in the related art, the disclosure aims to provide a welding method and product for improving stress corrosion resistance of a riser welded joint, so as to solve the problems of high hardness and high stress corrosion sensitivity of SCR riser welded joints.

This disclosure provides a welding method and product for improving stress corrosion resistance of a riser welded joint, specifically: under the protective gas of 80% Ar+20% CO₂, the SCR riser is welded using CMT welding technology, wherein the welding current of the root pass and the filler passes is 180 A to 200 A, the welding voltage is 20 V to 23 V, and the welding speed is 400 mm/min to 500 mm/min. The welding current of the cap pass is 130 to 150 A, the welding voltage is 13 to 15 V, and the welding speed is 245 mm/min to 255 mm/min.

Through the above technology, compared with the prior art, due to the improvement of the welding environment and the optimization of its supporting welding parameters including welding current, welding voltage and welding speed, not only the arc is stable, the splash is small, and the welding efficiency is high, but also the welding joint is well formed and the root residual height is small during the welding. The hardness of coarse grained zone is reduced, the negative effect of martensitic structure is eliminated, the anti-stress corrosion cracking ability of pipeline steel is improved, and the service life of SCR riser is greatly extended.

Preferably, the protective gas is sent 1.5 s to 2 s in advance before welding, and the protective gas is delayed 1.2 s to 1.5 s to turn off after welding.

Preferably, a bevel of the SCR riser adopts a U-shaped narrow gap bevel.

Preferably, for SCR risers ranging from 6 inches to 18 inches, a thickness of a blunt edge of the bevel is 1.1 mm to 1.7 mm.

Preferably, an arc transition is designed between the blunt edge and a bevel edge of the bevel, and a radius of the arc is 2.2 mm to 3.8 mm.

Preferably, for a 6-inch SCR riser, a bevel angle is set to 3°, and for a 12-inch SCR riser pipe and an 18-inch SCR riser, a bevel angle is set to 3.5°.

Preferably, a stick-out length of a welding wire is set to 12 mm as welding starts, and a stick-out length of the welding wire is set to 6 mm to 10 mm during welding.

Preferably, the to-be-welded portion of the SCR riser pipe is cleaned with acetone before welding, and then is polished.

Preferably, the SCR riser is preheated to 200° C. to 250° C. before welding.

According to another aspect of the disclosure, a SCR riser pipe welded joint prepared by the welding method of above is provided.

In summary, the above technical solutions provided by the disclosure have the following advantages compared to the related art:

1. This disclosure adopts the high heat input CMT welding of 80% Ar+20% CO₂ protection gas. The welding process has stable arc and small splash, and the welding wire actively draws back the wire to promote the drop off, which can significantly improve the welding efficiency, and ensure the welding joint is well formed. The root residual height is small, and the stress concentration of the welding joint is reduced. More importantly, it can reduce the hardness of the coarse grained heat affected zone of the welded joint, eliminate the negative influence of martensitic structure, improve the anti-stress corrosion cracking ability of pipeline steel, achieve the improvements of anti-corrosion fatigue and anti-stress corrosion cracking ability of offshore oil and gas pipelines, greatly enhance the service life of SCR risers, and provide a scientific basis for the prevention and control of corrosion cracking.

2. Meanwhile, by optimizing the bevel parameters of SCR risers, this disclosure can avoid the problem of excessively high root residual height or unstable fusion, and effectively improve the non-fusion defect that is easily occur at the inflection point.

### BRIEF DESCRIPTION OF DRAWINGS

FIG. 1 is a schematic diagram of CMT weld bead provided by an embodiment of the disclosure;

FIG. 2 is the macroscopic diagram of the welded joint provided by embodiment 1, comparative example 1 and comparative example 2, and, where (a) of FIG. 2 is comparative example 1, (b) of FIG. 2 is embodiment 1, and (c) of FIG. 2 is comparative example 2.

FIG. 3 is a schematic diagram of the coarse grained zone microstructure of the welded joint obtained by embodiment 1 and comparative example 2, where (a) of FIG. 3, (b) of FIG. 3 and (c) of FIG. 3 are respectively at 12 o'clock position, 3 o'clock position and 6 o'clock position of embodiment 1, and (d) of FIG. 3, (e) of FIG. 3 and (f) of FIG. 3 are respectively at 12 o'clock position, 3 o'clock position and 6 o'clock position of comparative example 2.

FIG. 4 shows the SSC test results of the root pass in the welded joint obtained by embodiment 1 and comparative example 2;

FIG. 5 shows the SSC test results of the root pass in the welded joint obtained by embodiment 1 and comparative example 2, where (a) of FIG. 5 is embodiment 2 and (b) of FIG. 5 is embodiment 1;

FIG. 6 shows the SSC test results of the root pass in the welded joint of the comparative example 3 to 5, where (a) of FIG. 6 is comparative example 3, (b) of FIG. 6 is comparative example 4, and (c) of FIG. 6 is comparative example 5;

FIG. 7 shows the SSC test results of the root pass in the welded joint of the comparative example 6 and 7, where (a) of FIG. 7 is comparative example 6 and (b) of FIG. 7 is comparative example 7.

### DESCRIPTION OF EMBODIMENTS

In order to make the objectives, technical solutions, and advantages of the disclosure clearer and more comprehensible, the disclosure is further described in detail with reference to the drawings and embodiments. It should be understood that the specific embodiments described herein serve to explain the disclosure merely and are not used to limit the disclosure.

The welding method comprising: using CMT to weld SCR riser under a shielding gas of 80% Ar +20% CO₂. The welding current for the root pass and fill pass is 180 A to 200 A, and the welding voltage is 20 V to 23 V, and the welding speed is 400 mm/min to 500 mm/min; the welding current of the cap pass is 130 to 150 A, the welding voltage is 13 to 15 V, and the welding speed is 245 mm/min to 255 mm/min.

The disclosure improves the welding environment and optimizes its supporting welding parameters, including welding current, welding voltage and welding speed. Not only the arc is stable, the splash is small, and the welding efficiency is high, but also the welding joint is well formed and the root residual height is small during the welding. The hardness of coarse grained zone is reduced, the negative effect of martensitic structure is eliminated, the anti-stress corrosion cracking ability of pipeline steel is improved, and the service life of SCR riser is greatly extended.

Further, the protective gas is sent 1.5 s to 2 s in advance before welding, and the protective gas is delayed 1.2 s to 1.5 s to turn off after welding, so as to ensure that the welding is completely carried out under protective gas of 80% Ar+20% CO₂.

Further, a bevel of the SCR riser adopts a U-shaped narrow gap bevel, which, while ensuring welding quality, can reduce the number of welding passes and the amount of filler wire required. This shortens welding time and construction costs, thereby improving welding efficiency.

Further, for SCR risers ranging from 6 inches to 18 inches, a thickness of a blunt edge of the bevel is 1.1 mm to 1.7 mm. When the blunt edge thickness is small, an excessively high root reinforcement will lead to an increase in the stress concentration factor, significantly reducing the service life of the SCR riser. When the root face thickness is large, the CMT process struggles to ensure stable root penetration in different welding positions, such as flat, overhead, and vertical positions.

Further, an arc transition is designed between the blunt edge and a bevel edge of the bevel, and a radius of the arc is R=3±0.8 mm, which increases the space at the root of the bevel and effectively mitigates the lack of fusion defects that easily occur at the transition point.

Further, for a 6-inch SCR riser, a bevel angle is set to 3°, and for a 12-inch SCR riser and an 18-inch SCR riser, a bevel angle is set to 3.5°. This ensures adequate fusion of the weld so as to improve welding quality and effectively control thermal stress and distortion.

Further, a stick-out length is set to 12 mm as welding starts, and maintained between 6 mm to 10 mm during welding. If the stick-out length is too long, the instantaneous current increases, which can easily lead to defects and cause wire sticking issues; if the stick-out length is too short, it may result in the burning of the contact tip, leading to welding defects.

Further, the to-be-welded portion of the SCR riser is cleaned with acetone before welding, and then is polished. The SCR riser is preheated to 200° C. to 250° C. before welding. Each weld pass is cleaned and ground using a grinder after welding.

Further, based on the strength level of API 5L X65 steel and the principle of high matching, PIPELINER or SUPRA MIG are selected to be the welding wire. The welding materials are required to have a yield strength greater than 450 MPa and a tensile strength greater than 570 MPa. Additionally, the DNV OS F101 standard recommends high matching, suggesting that the yield strength of the welding material should preferably exceed that of the base material by 80 MPa. Moreover, the use of low-hydrogen electrodes can effectively prevent welding hot cracks. The DNV OS F101 standard specifies that the diffusible hydrogen content of the welding material must be less than 5 ml/100 g. Both PIPELINER and SUPRA MIG welding wire meet the aforementioned requirements.

According to another aspect of the disclosure, a welded joint for an SCR riser using the aforementioned welding method is provided.

In order to better illustrate the implementation details of the disclosure, the following embodiments are provided to further illustrate the disclosure.

Both the embodiments and comparative examples use the following materials: the base material is X65-grade SCR riser with a diameter of 12 inches, wall thickness of 27 mm, and length ranging from 200 to 250 mm. The chemical composition of the base material is shown in Table 1, and its mechanical properties are listed in Table 2. This X65 pipeline steel follows the traditional composition design principles for pipeline steel, which involve reducing carbon content and increasing the content of alloying elements such as Mn and Mo. In addition to employing appropriate metallurgical techniques, the composition of the pipeline steel is strictly controlled.

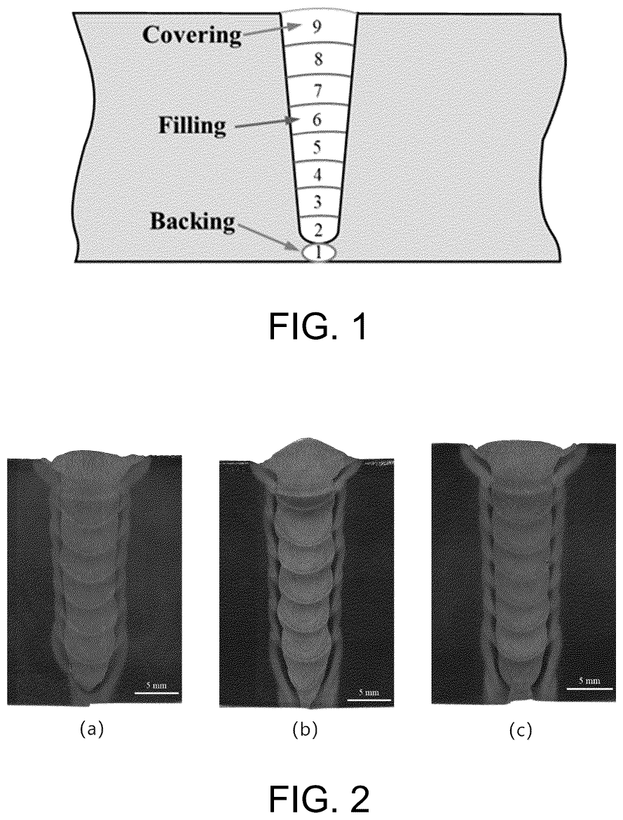

The CMT welding technology is selected for its low heat input, high deposition efficiency, and splash-free operation. The welding system is shown in FIG. 1. ER70S-6 low-carbon steel welding wire with a diameter of 1 mm is used as welding material, and its grade is PIPELINER or SUPRA MIG.

TABLE 1
X65 Chemical Composition of Base Material (mass fraction %)

| C | Mn | Si | P | S | Cu | Ni | Cr | Fe |
|---|---|---|---|---|---|---|---|---|
| <0.1 | 1.21 | 0.23 | <0.025 | <0.025 | 0.07 | 0.03 | 0.06 | remaining |
| | | | | | | | | amount |

TABLE 2
X65 Mechanical properties of base metal (mass fraction %)

| Yield | Tensile | Yield | elongation |
|---|---|---|---|
| strength/MPa | strength/MPa | ratio | rate/% |
| 450~560 | ≥531 | ≤0.91 | ≥24 |

### Embodiment 1

The bevel of the base material is prepared, and the bevel is a U-shaped narrow gap bevel. The thickness of blunt edge of the bevel is 1.4 mm, and a 3.4 mm arc transition is designed between the blunt edge and the bevel edge of the bevel. After removing surface oil stain and dust with acetone, the riser is placed on the welding fixture to ensure proper alignment of the bevel. The welding parameters are set at the welding power source and control box: the welding current of root pass and filler passes is 180 to 195 A, welding voltage is 21 to 22V, and welding speed is 450 mm/min. For the cap pass, the welding current is set to 135 to 145 A, the welding voltage is 13 to 14V, and the welding speed is 250 mm/min. When welding at different positions, the above parameters may vary slightly. Welding is conducted under a shielding gas of 80% Ar+20% CO₂, with a stick-out length of 10 mm. The number of welding layers is shown in FIG. 1, and before each weld pass, the bevel and interpass areas must be ground using a grinder.

### Embodiment 2

The bevel of the base material is prepared, and the bevel is a U-shaped narrow gap bevel. The thickness of blunt edge of the bevel is 1.1 mm, and a 2.2 mm arc transition is designed between the blunt edge and the bevel edge of the bevel. After removing surface oil stain and dust with acetone, the riser is placed on the welding fixture to ensure proper alignment of the bevel.

The welding parameters are set at the welding power source and control box: the welding current of root pass and filler passes is 180 to 190 A, welding voltage is 21 to 22V, and welding speed is 440 mm/min. For the cap pass, the welding current is set to 130 to 135 A, the welding voltage is 13 to 14V, and the welding speed is 248 mm/min. When welding at different positions, the above parameters may vary slightly. Welding is conducted under a shielding gas of 80% Ar +20% CO₂, with a stick-out length of 6 mm. The number of welding layers is shown in FIG. 1, and before each weld pass, the bevel and interpass areas must be ground using a grinder.

### Embodiment 3

The bevel of the base material is prepared, and the bevel is a U-shaped narrow gap bevel. The thickness of blunt edge of the bevel is 1.7 mm, and a 3.8 mm arc transition is designed between the blunt edge and the bevel edge of the bevel. After removing surface oil stain and dust with acetone, the riser is placed on the welding fixture to ensure proper alignment of the bevel. The welding parameters are set at the welding power source and control box: the welding current of root pass and filler passes is 190 to 200 A, welding voltage is 22 to 23V, and welding speed is 500 mm/min. For the cap pass, the welding current is set to 140 to 150 A, the welding voltage is 14 to 15V, and the welding speed is 254 mm/min. When welding at different positions, the above parameters may vary slightly. Welding is conducted under a shielding gas of 80% Ar +20% CO₂, with a stick-out length of 10 mm. The number of welding layers is shown in FIG. 1, and before each weld pass, the bevel and interpass areas must be ground using a grinder.

### Embodiment 4

The bevel of the base material is prepared, and the bevel is a U-shaped narrow gap bevel. The thickness of blunt edge of the bevel is 1.6 mm, and a 3.2 mm arc transition is designed between the blunt edge and the bevel edge of the bevel. After removing surface oil stain and dust with acetone, the riser is placed on the welding fixture to ensure proper alignment of the bevel. The welding parameters are set at the welding power source and control box: the welding current of root pass and filler passes is 185 to 195 A, welding voltage is 22 to 23V, and welding speed is 490 mm/min. For the cap pass, the welding current is set to 140 to 150 A, the welding voltage is 14 to 15V, and the welding speed is 255 mm/min. When welding at different positions, the above parameters may vary slightly. Welding is conducted under a shielding gas of 80% Ar+20% CO₂, with a stick-out length of 10 mm. The number of welding layers is shown in FIG. 1, and before each weld pass, the bevel and interpass areas must be ground using a grinder.

### Embodiment 5

The bevel of the base material is prepared, and the bevel is a U-shaped narrow gap bevel. The thickness of blunt edge of the bevel is 1.2 mm, and a 2.4 mm arc transition is designed between the blunt edge and the bevel edge of the bevel. After removing surface oil stain and dust with acetone, the riser is placed on the welding fixture to ensure proper alignment of the bevel. The welding parameters are set at the welding power source and control box: the welding current of root pass and filler passes is 180 to 190 A, welding voltage is 20 to 21V, and welding speed is 400 mm/min. For the cap pass, the welding current is set to 130 to 140 A, the welding voltage is 13 to 14V, and the welding speed is 245 mm/min. When welding at different positions, the above parameters may vary slightly. Welding is conducted under a shielding gas of 80% Ar +20% CO₂, with a stick-out length of 10 mm. The number of welding layers is shown in FIG. 1, and before each weld pass, the bevel and interpass areas must be ground using a grinder.

### Comparative Example 1

The procedure is the same as in embodiment 1, except that the shielding gas is 100% Ar.

### Comparative Example 2

The procedure is the same as in embodiment 1, except that the shielding gas is 50% Ar+50% CO₂.

Comparative Example 3

The procedure is the same as in embodiment 1, except that the welding parameters for the root pass and filler passes are adjusted as follows: the welding current is 130 to 140 A, the welding voltage is 12.5 to 13.5 V, the shielding gas is 50% Ar +50% CO₂, and the welding speed is 320 mm/min.

### Comparative Example 4

The procedure is the same as in embodiment 1, except that the welding parameters for the root pass and filler passes are adjusted as follows: the welding current is 130 to 140 A, the welding voltage is 12.5 to 13.5 V, the shielding gas is 50% Ar+50% CO₂, and the welding speed is 450 mm/min.

### Comparative Example 5

The procedure is the same as in embodiment 1, except that the welding parameters for the root pass and filler passes are adjusted as follows: the welding current is 130 to 140 A, the welding voltage is 12.5 to 13.5 V, the shielding gas is 50% Ar+50% CO₂, and the welding speed is 700 mm/min.

### Comparative Example 6

The procedure is the same as in embodiment 1, except that the shielding gas is 50% Ar+50% CO₂, and the welding speed is 450 mm/min.

### Comparative Example 7

The procedure is the same as in embodiment 1, except that the shielding gas is 50% Ar+50% CO₂, and the welding speed is 700 mm/min.

The macroscopic morphology from embodiment 1 and comparative examples 1 and 2 are shown in FIG. 2. In the comparative example 1, welding was performed under pure argon, the root pass was not fully penetrated. However, welded joints are well-formed of example 1 and comparative example 2.

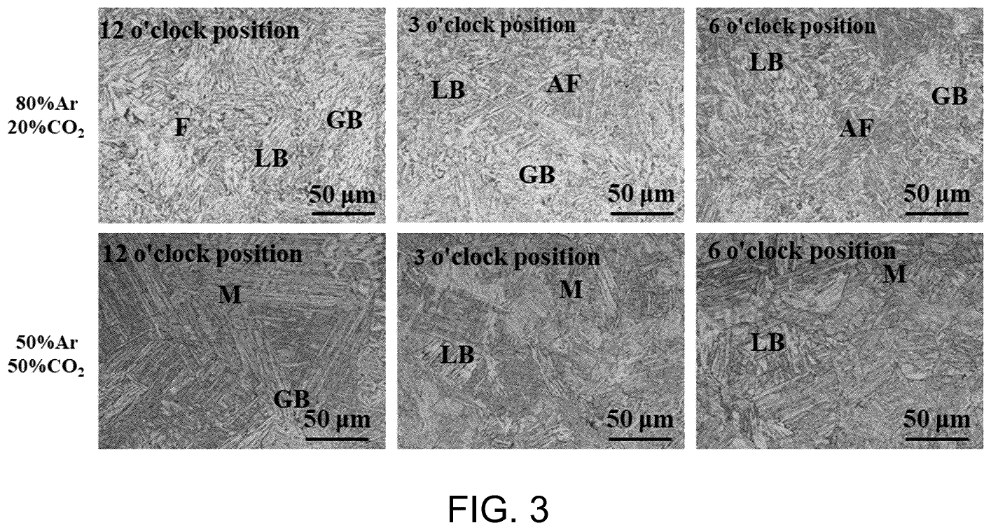

The welded joints obtained from embodiment 1 and comparative example 2 were sampled at 12 o'clock position, 3 o'clock position, and 6 o'clock position for metallographic test. The metallographic specimens were ground flat using 240# to 2000# sandpaper and polished until the surface is bright and without scratches using 1.0 W diamond polishing paste. The specimens were then etched with a 4% nitric acid alcohol solution. Since stress corrosion cracking mainly occurs in the coarse-grained heat-affected zone (CGHAZ) of the welded joint, the microstructures of the coarse-grained regions of the specimens obtained under different shielding gas are observed under a metallographic microscope, as shown in FIG. 3. In comparative example 2, the shielding gas is 50% Ar+50% CO₂, the microstructure of the coarse-grained region mainly consisted of lath martensite (M), lath bainite (LB), and a small amount of granular bainite (GB). X65 is a ferritic steel, and the mechanical properties of martensite differ highly from those of the matrix. Under the influence of hydrogen, martensite is more prone to separate from the matrix, leading to significant stress and strain concentration, which results in fracture failure. Additionally, martensite has a higher carbon content, and it has a potential difference with low-carbon phases such as ferrite, which facilitates the formation of micro-galvanic cells and accelerates corrosion.

In example 1, where the shielding gas is 80% Ar+20% CO₂, the microstructure of the coarse-grained region mainly consisted of acicular ferrite (AF), granular bainite (GB), and lath bainite (LB). The high dislocation density in acicular ferrite reduces the concentration of hydrogen at dislocations, resulting in fewer hydrogen molecules bound to individual dislocations, which is insufficient to reach the threshold for hydrogen-induced cracking. This leads to a more dispersed distribution of hydrogen, thereby mitigating the damage caused by hydrogen absorption. Therefore, the presence of AF significantly enhances the resistance of the welded joint to hydrogen-induced cracking. In summary, the 80% Ar+20% CO₂ shielding gas improves the cracking resistance of the welded joint by promoting the formation of acicular ferrite and eliminating martensite.

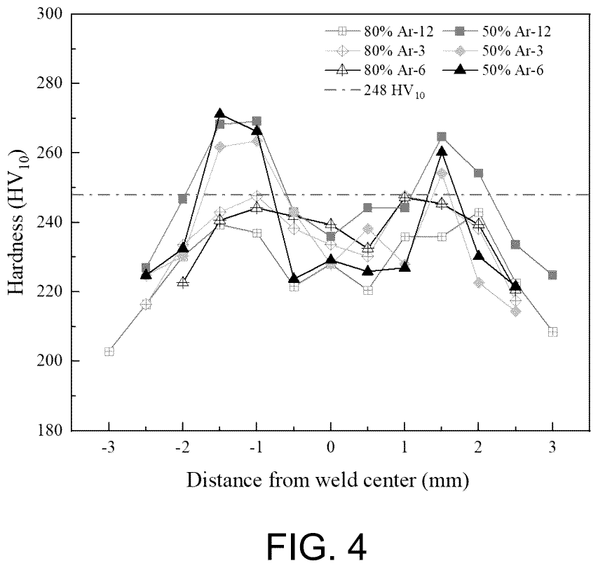

Considering that failures in practical applications mainly occur in the root pass, the Vickers hardness of the root pass of the welded joints obtained from example 1 and comparative example 2 is measured using an HV˜10 A Vickers hardness tester. The hardness is measured in four regions of the welded joint: the weld metal, fusion line, heat-affected zone (HAZ), and base metal, under a load of 10 kg. The test results are shown in FIG. 4 and Table 3. From the test results, it can be observed that the hardness values of the weld metal in the joints welded under the two shielding gas are essentially the same, while the hardness values of the heat-affected zone differ greatly. This is because the coarse-grained region of the joint welded under the traditional 50% Ar+50% CO₂ shielding gas mainly consists of martensite, which has a high carbon content and contains a high density of dislocations, resulting in high hardness. In contrast, the coarse-grained microstructure of the joint welded under the 80% Ar+20% CO₂ shielding gas specified in this disclosure mainly comprises acicular ferrite and granular bainite. Compared to martensite, these two microstructures require a longer cooling time, leading to more sufficient diffusion of carbon within the specimen, thereby leading to a reduction in hardness. According to the NACE MR0175-2009 standard, the hardness of metals in acidic hydrogen sulfide environments should not exceed 248 HV₁₀. The test results indicate that the welded joint obtained using the shielding gas specified in this disclosure meets the standard requirements, while the conventional shielding gas cannot.

TABLE 3
Hardness Values of Welded Joints under Different Shielding Gases (HV₁₀)

| o'clock | Shielding | Distance from the Weld Centerline (mm) | | | | | | | | | | |
|---|---|---|---|---|---|---|---|---|---|---|---|---|
| position | Gas | ~2.5 | ~2 | ~1.5 | ~1 | ~0.5 | 0 | 0.5 | 1 | 1.5 | 2 | 2.5 |
| 12 | 50% Ar + | 216 | 249 | 266 | 239 | 230 | 228 | 234 | 226 | 258 | 261 | 235 |
| 3 | 50% CO₂ | 218 | 224 | 259 | 269 | 232 | 228 | 231 | 231 | 258 | 241 | 225 |
| 6 | | 214 | 245 | 263 | 249 | 239 | 243 | 248 | 243 | 269 | 242 | 230 |
| 12 | 80% Ar + | 216 | 230 | 239 | 237 | 221 | 228 | 220 | 235 | 235 | 243 | 223 |
| 3 | 20% CO₂ | 216 | 233 | 243 | 248 | 238 | 233 | 230 | 247 | 245 | 238 | 218 |
| 6 | | 215 | 223 | 241 | 244 | 242 | 239 | 232 | 247 | 245 | 239 | 221 |

The root pass of the welded joints obtained in embodiments 1 and 2 are under stress corrosion tests, and the welded joint samples with a certain deflection are in NACE TM0177˜Solution A where 99.5% hydrogen sulfide gas is injected into for 720 hours under the test conditions of 1bar pressure and 24° C.±3. Deflection loading is carried out on the sample with the welding root side as the tension face, and the loading load is 80% of the yield strength of the base material. The loading formula is as follows:

$$y = \frac{( 3 {H}^{2} - 4 {A}^{2} ) σ}{12 Et}$$

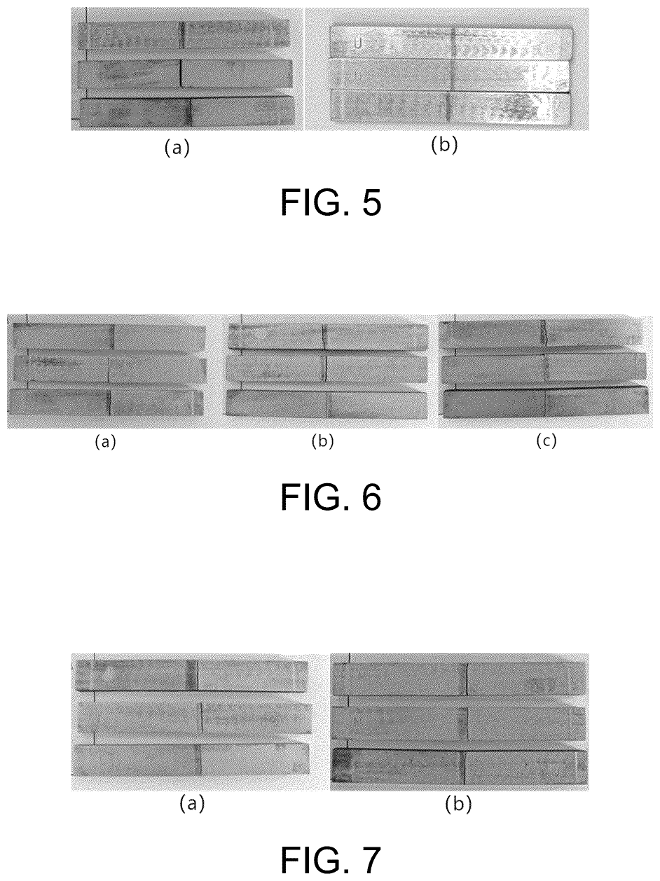

After 720 hours of testing, the tensile surfaces of the two welded joint samples were tested under a low-power microscope at a magnification of ×10, as shown in FIG. 5. All samples welded under the 50% Ar+50% CO₂ shielding gas fractured completely, indicating that their resistance to stress corrosion cracking is inadequate. It is also found that the fractures all occurred in the heat-affected zone (HAZ). In contrast, the samples welded under the 80% Ar+20% CO₂ shielding gas showed no cracking or fractures on their tensile surfaces, indicating that these samples are not sensitive to hydrogen sulfide stress corrosion cracking.

Comparative examples 3 to 5 are conducted under low heat input. The welded joints obtained from comparative examples 3, 4, and 5 are under hardness testing and root pass SSC (sulfide stress corrosion cracking) test. The hardness test results are shown in Table 4, and the root pass SSC test results are illustrated in FIG. 6. As can be seen from Table 4, the hardness values of the coarse-grained regions in the welded joints obtained under the three sets of parameters are relatively high, significantly exceeding the standard limit of 248 HV₁₀. Furthermore, as shown in FIG. 4, the SSC resistance of the welded joints obtained under the three sets of parameters failed to meet the required standards.

TABLE 4
Hardness Values of Welded Joints under Low Heat Input and Different Welding Speeds (HV₁₀)

| | | Welding | | | | | | | | | | | |
|---|---|---|---|---|---|---|---|---|---|---|---|---|---|
| | o'clock | Speed | Distance from the Weld Centerline (mm) | | | | | | | | | | |
| ID | position | (mm/min) | ~2.5 | ~2 | ~1.5 | ~1 | ~0.5 | 0 | 0.5 | 1 | 1.5 | 2 | 2.5 |
| 1 | 12 | 320 | 211 | 226 | 232 | 271 | 256 | 247 | 246 | 252 | 252 | 234 | 229 |
| | 3 | | 225 | 240 | 300 | 260 | 244 | 246 | 243 | 270 | 266 | 301 | 234 |
| | 6 | | 227 | 274 | 286 | 245 | 240 | 239 | 239 | 248 | 293 | 289 | 248 |
| 2 | 12 | 450 | 235 | 256 | 276 | 235 | 245 | 243 | 242 | 236 | 290 | 301 | 244 |
| | 3 | | 231 | 223 | 266 | 247 | 239 | 238 | 229 | 240 | 306 | 289 | 224 |
| | 6 | | 243 | 291 | 290 | 248 | 252 | 245 | 251 | 243 | 292 | 305 | 244 |
| 3 | 12 | 700 | 204 | 247 | 296 | 286 | 248 | 248 | 243 | 256 | 307 | 274 | 242 |
| | 3 | | 233 | 257 | 300 | 278 | 227 | 235 | 241 | 294 | 285 | 245 | 224 |
| | 6 | | 245 | 265 | 307 | 238 | 237 | 238 | 244 | 324 | 285 | 259 | 231 |

Comparative examples 6, 7 are conducted under low heat input. The welded joints obtained from comparative examples 6, 7 are under hardness testing and root pass SSC test. The hardness test results are shown in Table 5, and the root pass SSC test results are illustrated in FIG. 7. As can be seen from Table 5, although the hardness values of the coarse-grained region in the welded joints obtained under the two sets of parameters lower than those of the low heat input, still exceed the standard requirement of 248 HV₁₀. As shown in FIG. 13, the SSC performance of the welded joints under these two parameters is unsatisfactory. However, the hardness is slightly lower than that of the low heat input process (i.e., comparative examples 3 to 5), and no hardness values above 300 HV₁₀ are observed.

TABLE 5
Hardness Values of Welded Joints under High Heat Input and Different Welding Speeds (HV₁₀)

| | | Welding | | | | | | | | | | | |
|---|---|---|---|---|---|---|---|---|---|---|---|---|---|
| | o'clock | Speed | Distance from the Weld Centerline (mm) | | | | | | | | | | |
| ID | position | (mm/min) | ~2.5 | ~2 | ~1.5 | ~1 | ~0.5 | 0 | 0.5 | 1 | 1.5 | 2 | 2.5 |
| 1 | 12 | 450 | 195 | 212 | 243 | 253 | 228 | 224 | 223 | 218 | 259 | 263 | 248 |
| | 3 | | 204 | 238 | 262 | 240 | 240 | 238 | 260 | 246 | 243 | 230 | 201 |
| | 6 | | 227 | 247 | 272 | 275 | 243 | 235 | 244 | 244 | 264 | 254 | 233 |
| 2 | 12 | 700 | 225 | 230 | 270 | 260 | 243 | 228 | 238 | 228 | 254 | 222 | 214 |
| | 3 | | 216 | 249 | 265 | 239 | 230 | 228 | 233 | 225 | 258 | 260 | 234 |
| | 6 | | 214 | 245 | 263 | 249 | 239 | 242 | 248 | 242 | 269 | 241 | 230 |

In prior art, CMT welding is typically performed under a shielding gas of 50% Ar+50% CO₂. However, whether under low heat input or high heat input, merely improving the welding parameters alone cannot address the issues of high hardness and high stress corrosion sensitivity of SCR (Steel Catenary Riser) welding joints. This disclosure proposes modifications to the shielding gas, along with optimization of welding parameters such as welding current, welding voltage, and welding speed. These improvements can effectively reduce the hardness of SCR welding joints and achieve better resistance to SSC (Sulfide Stress Cracking), meeting the specific requirements for oil and gas transportation in deep-sea acidic environments. Additionally, this disclosure optimizes the structural parameters of the bevel, further enhancing welding effectiveness. By adopting high heat input CMT welding technology with an 80% Ar+20% CO₂ shielding gas, the welding process exhibits stable arc, minimal spatter, and high welding efficiency. The resulting welding joints have excellent formation, small root reinforcement, reduced hardness in the coarse-grained zone, and elimination of the negative effects of martensitic microstructure. This significantly improves the stress corrosion cracking resistance of pipeline steel and greatly extends the service life of SCR risers.

In the disclosure, the terms “first” and “second” are only used for descriptive purposes and cannot be understood as indicating or implying relative importance or implicitly indicating the number of indicated technical features. Thus, the features defined with “first” and “second” may explicitly or implicitly include one or more of these features. In the description of the disclosure, “plurality” means two or more than two, unless otherwise expressly and specifically defined.

The above description is only preferred embodiments of the disclosure and is not intended to limit the disclosure. Any modifications, equivalent replacements, and modifications made without departing from the spirit and principles of the disclosure should fall within the protection scope of the disclosure.

1. A welding method for improving the stress corrosion resistance of a welded joint of a riser pipe, comprising:
performing 5G welding on a SCR riser pipe using CMT welding technology under a protective gas of 80% Ar+20% CO₂, in which a welding current of a root pass and filler passes is 180 A to 200 A, a welding voltage is 20 V to 23 V, and a welding speed is 400 mm/min to 500 mm/min, a welding current of a cap pass is 130 to 150 A, a welding voltage is 13 to 15 V, and a welding speed is 245 mm/min to 255 mm/min, wherein a bevel of the SCR riser pipe is a U-shaped narrow gap bevel, as for SCR riser pipe ranging from 6 inches to 18 inches, a thickness of a blunt edge of the bevel is 1.1 mm to 1.7 mm,
wherein the protective gas is sent 1.5 s to 2 s in advance before welding, and the protective gas is delayed 1.2 s to 1.5 s to turn off after welding.

2. (canceled)

3. The welding method according to claim 1, wherein an arc transition is designed between the blunt edge and a bevel edge of the bevel, and a radius of the arc is 2.2 mm to 3.8 mm.

4. The welding method of claim 1, wherein for a 6-inch SCR riser pipe, a bevel angle is set to 3°, and for a 12-inch SCR riser pipe and an 18-inch SCR riser, a bevel angle is set to 3.5°.

5. The welding method of claim 1, wherein a stick-out length of a welding wire is set to 12 mm as welding starts, and a stick-out length of the welding wire is set to 6 mm to 10 mm during welding.

6. The welding method of claim 1, wherein a to-be-welded portion of the SCR riser pipe is cleaned with acetone before welding, and then is polished.

7. The welding method of claim 1, wherein the SCR riser pipe is preheated to 200°° C. to 250° C. before welding.

8. A SCR riser pipe welded joint prepared by the welding method according to claim 1.
